(19) United States
(12) Patent Application Publication
(10) Pub. No.: US 2021/0014949 A1
(43) Pub. Date: Jan. 14, 2021

(54) LED LIGHTING DEVICE, PARTICULARLY FOR VEHICLES

(71) Applicant: Elmos Semiconductor SE, Dortmund (DE)

(72) Inventors: Andre Sudhaus, Dortmund (DE); Niyant Patel, Novi, MI (US)

(21) Appl. No.: 16/340,746

(22) PCT Filed: Oct. 12, 2017
(86) PCT No.: PCT/EP2017/076106

§ 371 Date: Apr. 10, 2019

(30) Foreign Application Priority Data
Oct. 13, 2016 (DE) 10 2016 119 584.7
Mar. 7, 2017 (EP) PCT/EP2017/055286
Oct. 6, 2017 (DE) 10 2017 123 259.1
Oct. 6, 2017 (DE) 10 2017 123 260.5

(51) Int. Cl. H05B 45/3725; H05B 45/50; H05B 45/46

(52) U.S. Cl. CPC H05B 45/3725; H05B 45/46; H05B 45/50

(57) ABSTRACT

A device for supplying at least two LED chains with electricity detects and then signals an interruption in the current path through the LED chains. A sub-device, in the event of a short circuit of an LED within a first LED chain, brings about a detection and/or a subsequent signalling of an interruption of the current path within another LED chain of these at least two LED chains. The associated method comprises the steps of detecting the short circuit of an individual LED in a first LED chain and of interrupting, as a result, the flow of current through at least one other LED chain and subsequently detecting this interruption of the flow of current through the other LED chain by means of the interruption detection system already existing as required.

### CROSS-REFERENCE TO RELATED APPLICATIONS

This application is a national stage of, and claims priority to, Patent Cooperation Treaty Application No. PCT/EP2017/076106, filed on Oct. 12, 2017, which application claims priority to German Application No. DE 10 2016 119 584.7, filed on Oct. 13, 2016, Patent Cooperation Treaty Application No. PCT/EP2017/055286, filed on Mar. 7, 2017, German Application No. DE 10 2017 123 259.1 filed on Oct. 6, 2017, and German Application No. DE 10 2017 123 260.5, filed on Oct. 6, 2017, which applications are hereby incorporated herein by reference in their entireties.

The disclosure relates to an LED lighting device, particularly for vehicles. In particular the disclosure relates to devices and methods for supplying LED chains with electricity, with the possibility of detecting short circuits of individual LEDs.

LED lighting devices for vehicles have formed part of the prior art for a number of years. LED lighting means are preferred over filament lighting means due to their service life and their lack of susceptibility to malfunctions.

In LED lighting devices for vehicles, what are known as LED chains are sometimes used, which are formed of series connections of multiple LEDs. What are known as multi-channel power supply units in the form of ICs are known as drivers of LED lighting devices of this kind and for each channel have a failure monitoring system in the form of, for example, a current or voltage detector. Whereas an interruption in current through the LED chain or a total short circuit of the LED chain can be quite easily identified by the detector, the detection of short circuits of individual LEDs causes problems. This is due to the fact that unfortunately the voltage drop across an LED chain in normal operation is not constant and in particular is dependent on the age of the LEDs, temperature thereof, etc. A voltage drop that changes slightly, as occurs for example in the event of a short-circuit of an individual LED, therefore cannot be detected unequivocally as a short circuit.

Devices for operating LED chains, that is to say LED series circuits, are known from DE-A-10 2008 037 551, DE-A-10 2009 028 101, AT-U-005 190, US-A-2008/0204029 and WO-A-2012/077013.

The disclosure relates to a device for supplying at least two LED chains L₁,L₂,L₃ with electricity, in which the failure of individual LEDs within the LED chains as a result of an LED short circuit, referred to hereinafter by the reference sign SC, constitutes a fault that is to be detected. Integrated circuits used for supplying electricity to LED chains of this kind typically are able to identify and then signal an interruption in the current path within one of these LED chains L₁,L₂,L₃. However, the identification of short circuits of individual LEDs is not possible in the prior art.

Document DE-A-10 2014 112 171 discloses a method for identifying a short-circuit in a first light-emitting diode element, in which the first light-emitting diode element within the scope of a specific measurement is operated in a reverse-bias region, a check is performed to ascertain whether an electrical current flows across the first light-emitting diode element in the reverse direction, and a short circuit is identified if the check reveals that the current flows in the reverse direction and is greater than a predefined leakage current. A methodology of this kind is unsuitable for short-circuit identification in an LED chain.

DE-A-10 2008 047 731 discloses a method for detecting faults in a lighting device having a plurality of light-emitting diodes connected in series, wherein the fault detection is achieved by determining the voltage drop of individual series-connected light-emitting diodes or by determining the voltage drop of groups of a plurality of the series-connected light-emitting diodes and by evaluating this voltage drop or these voltage drops. A particular feature is that the evaluation is performed by a comparison with a reference value that changes over time. Here, it is disadvantageous that a separate voltage-determining device is required for the voltage drop, which increases the outlay for the identification of short circuits of individual LEDs.

DE-A-10 2007 001 501 discloses a device which by means of an analogue-to-digital converter in a microcontroller monitors the individual voltage drops across the LEDs of an LED chain during operation. It is disadvantageous that each LED has to be contacted.

DE-A-10 2006 058 509 likewise discloses a circuit with intermediate tapping points.

Circuits of this kind cannot be installed in a small housing of an integrated circuit since they require too many connections.

The object of the disclosure is therefore to create a solution that does not have the above disadvantages of the prior art and has further advantages.

In particular, the object of the disclosure is to create a lighting device, particularly for vehicles, in which a plurality of LED chains can be examined for a short circuit of an individual LED, more specifically with minimal outlay in respect of the circuitry.

In order to achieve this object, the disclosure proposes a lighting device, particularly for vehicles, which is provided with
at least two LED chains, each of which has a series circuit formed of a plurality of LEDs,
a multi-channel power supply unit for the at least two LED chains with at least two current sources, wherein each LED chain is associated with a power source and each LED chain is electrically connected on the one hand to a power supply output connection of the power supply unit and on the other hand to a reference potential, and
a monitoring device for identifying a short circuit in a predefinable number of LEDs of one of the at least two LED chains, wherein the monitoring device is provided with
   a detector per LED chain for identifying and signalling an interruption in the current flow in said LED chain,
   a controllable interrupter switch per LED chain, which has a control connection controllable by means of a control signal and a current path which is switched conductively or non-conductively depending on the magnitude of the control signal and which is connected in series with the LED chain, and
at least one coupling component assembly connected between the control connections of the at least two interrupter switches for enabling a flow of current from the control connection of one interrupter switch to the control connection of the other interrupter switch when a voltage of a value greater than a predefinable switching voltage is applied across the coupling component assembly
wherein, in the event of a short circuit of the predefined number of LEDs in one of the two LED chains, a voltage at least equal to the switching voltage drops across the coupling component assembly, and therefore the control signal of the interrupter switch associated with the other LED chain assumes a value opening this interrupter switch, such that the detector associated with this other LED chain signals an interruption of the current flow in the other LED chain.

The key feature of the disclosure is to couple to LED chains of an LED lighting device to one another and to provide each LED chain with an interrupter switch. The controllable interrupter switches are coupled to one another by a coupling component assembly. If the voltage difference between the control connections of the interrupter switches of the two LED chains exceeds a predefinable value, which is the case, depending on a specified or desired value, in the event of the short circuit of an individual LED or the short circuit of a predefinable relatively small number of LEDs in one of the LED chains, this disruption and the associated reduction in the voltage across the “disrupted” LED chain translates into a change in the voltage across the coupling component assembly, such that this becomes conductive and therefore activates the interrupter switch of the other LED chain, such that the interrupter switch of this other LED chain opens, which in turn can be detected reliably by the detector associated with this other LED chain.

In accordance with the disclosure the short-circuit of an individual LED or the short circuit of two or fewer LEDs in one of the LED chains is thus converted into an interruption of the other LED chain. The driver for this other LED chain, as explained above, is provided with a corresponding fault detector, which identifies the interruption of the LED chain. Thus, in order to realise the object of the disclosure, merely one interrupter switch per LED chain and a coupling component assembly that must perform the function of being electrically conductive from a predefinable voltage drop are necessary. This is realised in the simplest case by diodes. Ultimately, only few electronic components are thus necessary in order to realise the object of the disclosure as an “add on” so to speak of a current supply unit or, broadly speaking, power supply unit for a multi-channel LED lighting device.

In an advantageous development of the disclosure it can be provided that the coupling component assembly enables a flow of current in one direction or in the other, opposite direction only with a predefinable sign of the voltage dropping across it or depending on the sign of the voltage dropping across it.

In an advantageous example of the disclosure it can be provided that the coupling component assembly has one or more diodes which can be connected anti-parallel in order to enable a flow of current in both directions.

In a further advantageous example of the disclosure it can be provided that the monitoring device, in the case of more than two LED chains, has a number of coupling component assemblies equalling the number of LED chains, wherein the control connections of the interrupter switches associated with the LED chains are coupled cyclically in each case by means of a coupling component assembly and therefore as a ring circuit.

In a further advantageous example of the disclosure it may be provided that each coupling component assembly enables a flow of current in the same direction through the ring circuit.

In an advantageous development of the disclosure it may be provided that the monitoring device UWE, in the case of more than two LED chains, has a number of coupling component assemblies equalling the number of LED chains, wherein the control connections of the interrupter switches associated with the LED chains are coupled in a star circuit by means of the coupling component assemblies (KBA).

In an advantageous example of the disclosure it may be provided that each coupling component assembly enables unidirectional flows of current.

In a further advantageous example of the disclosure it may be provided that the interrupter switches are formed as bipolar, FET or MOS transistors.

As already explained above, the disclosure relates to the power supply for electroluminescent light sources which are formed as circuit assemblies not intended for a specific application. However, it is particularly suitable for application in automotive lights. In the widest sense, the disclosure therefore relates to a monitoring device for assemblies of signal or lighting devices or assemblies of optical signal or lighting devices or of arrangements of lighting devices for the vehicle interior, or of arrangements or a particular design of portable emergency signal devices in vehicles.

As discussed above, the object of the disclosure is therefore to create a solution which does not have the above disadvantages of the prior art and which has further advantages.

The basic concept in this disclosure is that of utilising the identification, provided already, of interruptions of the current path of an LED chain of at least two LED chains L₁,L₂,L₃ for identifying a short circuit of an individual LED in another LED chain of the at least two LED chains L₁,L₂,L₃. To this end, a special sub-device is necessary, which is inserted between the power supply, typically a current source IS₁, IS₂, IS₃ within an integrated circuit, and which has at least two LED chains L₁,L₂,L₃ and couples these such that a short circuit of an individual LED or a short circuit in a few (two, three or four) LEDs in an LED chain leads to an interruption of the flow of current in at least one other LED chain. Since the integrated circuit, at least in applications for the automotive industry, has aids for identifying an interruption in the flow of current in one or more of the connected LED chains L₁,L₂,L₃, it is thus able to identify and output a fault. It has been found here that it generally is not important to specify what fault (short circuit of an individual LED or interruption of an LED chain) is present or at which LED chain this fault is present. Thus, this information can be sacrificed in favour of the identification of a short circuit of an individual LED.

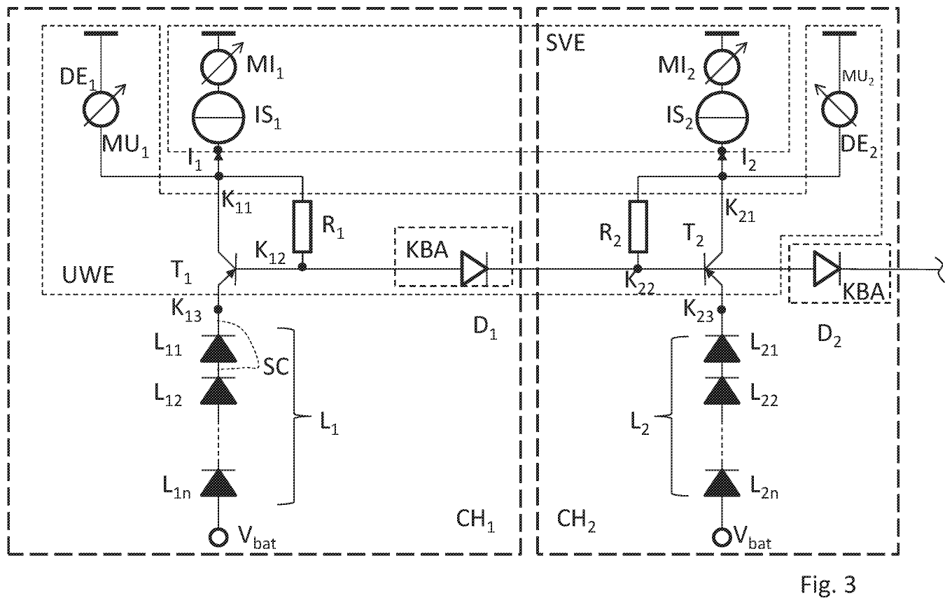

A method for detecting the failure of an individual LED in a lighting device having at least two LED chains L₁,L₂,L₃ is therefore proposed, which method as a first step provides the detection of an individual LED short circuit in a first LED chain of the at least two LED chains L₁,L₂,L₃ by a first detection means and an interruption, caused by this detection, of the flow of current through at least one other LED chain of the at least two LED chains L₁,L₂,L₃ by an interruption means. The following text shall disclose that a first transistor T₁ and first diode D₁ in conjunction with a first resistor R₁, as shown in FIG. 3 for example, are proposed as first detection means in the exemplary example presented here. The corresponding detection means of the other LED chain of the at least two LED chains L₁,L₂,L₃ is proposed as interruption means. In the examples presented here, the transistor thus performs a dual function as detection means and as interruption means. This does not necessarily have to be the case. As an anticipatory example, reference is made here already to a transistor T₂ in FIG. 3 by way of illustration. Thus, once the flow of current has passed through the other LED chain of the at least two LED chains, the short circuit of an individual LED is converted into an LED chain interruption in another LED chain. The measurability and thus the detectability by the integrated circuit are hereby provided, which solves the technical problem. The last step is therefore detection of the interruption of the flow of current through the other LED chain of the at least two LED chains L₁,L₂,L₃.

To summarise, the proposed device for supplying at least two LED chains L₁,L₂,L₃ with electricity is characterised in that it has a sub-device StOC, which, in the event of the short circuit of one or more LEDs within a first LED chain of the at least two LED chains L₁,L₂,L₃, brings about an identification and/or subsequent signalling of an interruption of the current path within another LED chain of these at least two LED chains L₁,L₂,L₃, referred to hereinafter as the second LED chain. A precondition is that the proposed device has measurement means MI₁,MU₁; MI₂,MU₂; MI₃,MU₃ for detecting an interruption of an LED chain and suitable signalling means for being able to forward (signal) the detection result to a control device.

The particular advantage here lies in the conversion of the manifestation of a short circuit of an individual LED into the interruption of an LED chain, detectable by the integrated circuit (the device).

A further example of the proposed device is characterised in that a transistor T₁,T₂,T₃ is disposed in each current path of each LED chain of these at least two LED chains L₁,L₂,L₃. Here, the transistor T₁,T₂,T₃ is preferably a bipolar transistor. Each transistor T₁,T₂,T₃ is part of the sub-device. In the event of fault-free operation, each transistor T₁,T₂,T₃ is conductive. At least one transistor T₁,T₂,T₃ of the second LED chain of the at least two LED chains L₁,L₂,L₃, hereinafter referred to as the second transistor, is switched to be blocking if, in a first LED chain of the at least two LED chains L₁,L₂,L₃, a short circuit SC along the LED chain occurs. This construction has the advantage that it is very compact and can be provided with few components.

A further example of the proposed device is characterised in that the at least one transistor of the first LED chain of the at least two LED chains L₁,L₂,L₃, referred to hereinafter as the first transistor, is a bipolar transistor T₁,T₂,T₃, and in that the at least one second transistor of the second LED chain of the at least two LED chains L₁,L₂,L₃ likewise is a bipolar transistor T₁,T₂,T₃. Here, the base of the first transistor is connected to the base of the second transistor via at least one diode D₁,D₂,D₃,D₁₁,D₁₂,D₂₁,D₂₂,D₃₁,D₃₂ directly or indirectly, in particular via a series resistor Rᵥ₁,Rᵥ₂. The base of the first transistor is energised by means of an operating point setting so as to safely connect through the transistor in normal operation. It is particularly advantageous if this operating point setting is made via an operating point resistor R₁,R₂,R₃ which connects the control connection (the base or the gate) of the first transistor to the power source IS₁,IS₂,IS₃ of the first LED chain in the current path of which the first transistor is located.

The advantage of this arrangement is that the first transistor is conductive in normal operation and the base current in the event of a fault can be siphoned off through the base-emitter diode of the corresponding transistor of the other LED chain in the event of a short circuit to an individual LED, whereby the first transistor begins to block. Since MOS transistors first are not current-controlled and second do not have the necessary base-emitter diode, which performs the actual LED short-circuit detection, the detection function for an individual LED short circuit and the interruption function for the interruption of the flow of current through the LED chain must be separated in the case of the use of MOS transistors. The detection function is performed then by a separate detection device. This may be a separate PN diode, i.e. an auxiliary diode, for example. This auxiliary diode d₁,d₂,d₃ is necessary as detection device if a MOS transistor is used as transistor T₁,T₂,T₃ instead of a bipolar transistor. The auxiliary diode in question is then connected between the gate of the MOS transistor as second node K₁₂,K₂₂,K₂₃ of the LED chain in question and the connection node K₁₃,K₂₃,K₃₃ between MOS transistor T₁,T₂,T₃ and the LED chain in question. The polarity of the auxiliary diode d₁,d₂,d₃ is selected in accordance with the transistor type at the time of connection. The auxiliary diode d₁,d₂,d₃ of the LED chain in question then emulates the function of the base-emitter diode of a bipolar transistor as detection device and forces the potential of a transistor of another channel to a potential at which the gate-source path no longer has sufficient voltage, whereby this starts to block if there is a short circuit of an individual LED or a number of LEDs along the LED chain in question. With the use of MOS transistors, the functions of the detection device (first auxiliary diode) and interruption device (transistor) are thus separated, whereas in the case of bipolar transistors they can be carried out by the bipolar transistors simultaneously (transistor alone). With use of a bipolar transistor as a transistor T₁,T₂,T₃, the auxiliary diode d₁,d₂,d₃ therefore is not absolutely necessary. A construction with auxiliary diodes and MOS transistors is therefore particularly advantageous because it enables a complete integration in integrated CMOS circuits within the scope of CMOS standard processes.

A further example of the proposed device is characterised in that the device links a plurality of LED chains to one another. Here, the device now comprises at least three LED chains L₁,L₂,L₃. The example of the device relates to a specific topology of the connection of the short-to-open converter StOC. In each current path of each LED chain of these at least three LED chains L₁,L₂,L₃ there is a transistor T₁,T₂,T₃, in particular a bipolar transistor. Each transistor T₁,T₂,T₃ is again part of the sub-device. Each transistor T₁,T₂,T₃ is again connected here such that it is conductive in fault-free operation. In the event of a fault constituted by a short circuit along an LED chain, at least one of the transistors T₁,T₂,T₃ of the LED chains not affected by the short-circuit is always switched to be blocking. This occurs if, in at least one other LED chain of the at least three LED chains L₁,L₂,L₃ which it is not the LED chain of the transistor switched to be blocking, a short circuit occurs along the LED chain. The control connection (base or gate) of each transistor of a preceding LED chain is connected here to the control connection (base or gate) of the following transistor via at least one diode D₁,D₂,D₃,D₁,D₁₂,D₂₁,D₂₂,D₃₁,D₃₂ directly or indirectly, in particular via a resistor Rᵥ₁,Rᵥ₂,Rᵥ₃. The words “preceding” and “following” relate here to a virtual numbering of the m LED chains from 1 to m.

Here, each LED chain follows an LED chain with a lower number and precedes an LED chain with a higher number. The first LED chain shall be understood here to be the chain following the m^{th} LED chain, and the m^{th} LED chain to be the chain preceding the first LED chain. All elements of a preceding LED chain are therefore referred to here as “preceding”. All elements of a following LED chain are referred to as following. The control connection (base or gate) of the preceding transistor is energised by means of an operating point setting. The control connection (base or gate) of the preceding transistor is particularly preferably connected via an operating point resistor R₁,R₂,R₃ to the power source IS₁,IS₂,IS₃ of the associated LED chain in the current path of which the preceding transistor is disposed. In the case of a MOS transistor as following transistor the control connection (base or gate) of the following transistor is connected to a connection of the following LED chain, to which it is connected, via an associated following auxiliary diode. In the case of a MOS transistor as preceding transistor, the control connection (bass or gate) of the preceding transistor is connected to a connection of the preceding LED chain, to which it is connected, via an associated preceding auxiliary diode. The particular feature of this example of the device is that the diodes are connected such that they allow a circular flow of current through the diodes. The channels are thus connected to one another in a ring.

A further example of the proposed device is characterised in that the device likewise has at least three LED chains L₁,L₂,L₃ and instead of being connected in ring form, as described before, are now connected to one another in a star shape via diodes. In each current path of each LED chain of these three LED chains L₁,L₂,L₃ there is again a transistor T₁,T₂,T₃, in particular a bipolar transistor or MOS transistor with a control connection (base or gate) and in each case two further connections. Each transistor T₁,T₂,T₃ is again part of the corresponding sub-device. Each transistor T₁,T₂,T₃ is again connected such that it is conductive in fault-free operation. Again, at least one of these transistors T₁,T₂,T₃ is always switched to be blocking if, in at least one other LED chain of the at least three LED chains L₁,L₂,L₃ which is not the LED chain of the transistor switched to be blocking, a short circuit occurs along the LED chain in question. The control connection (base or gate) of each transistor of a preceding LED chain is now connected, however, to the control connection (base or gate) of the following transistor via at least two diode pairs D₁₁,D₁₂; D₂₁,D₂₂; D₃₁,D₃₂ connected one after the other in series and formed in each case of two diodes D₁₁,D₁₂; D₂₁,D₂₂; D₃₁,D₃₂ connected anti-parallel. The diodes have two connections. Each diode may be connected in series with a resistor. The control connection (base or gate) of the preceding transistor is energised by means of an operating point setting. This energisation is preferably provided in such a way that the control connection (base or gate) of the preceding transistor is connected via an operating point resistor R₁,R₂,R₃ to the power source IS₁,IS₂,IS₃ of the associated LED chain in the current path of which the preceding transistor is disposed. In the case of a MOS transistor as following transistor, the control connection (base or gate) of the following transistor is connected to a connection of the following LED chain, to which it is connected, via an associated following auxiliary diode. In the case of a MOS transistor as preceding transistor, the control connection (base or gate) of the preceding transistor is connected to a connection of the preceding LED chain, to which it is connected, via an associated preceding auxiliary diode. The diodes are connected here such that they are connected to a connection with a common star point (SP).

The disclosure will be explained in greater detail hereinafter on the basis of a number of exemplary examples and with reference to the drawings, in which, specifically:

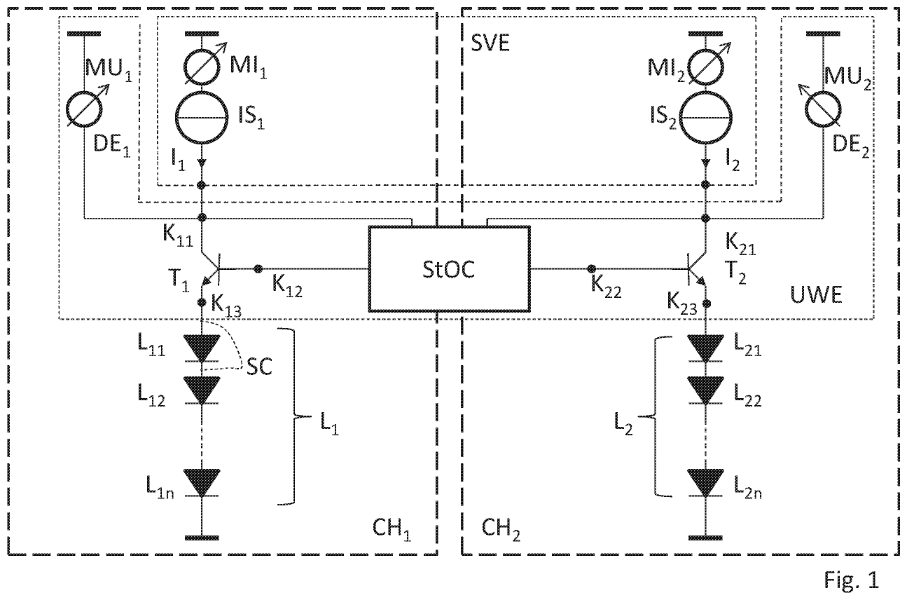

FIG. 1 shows in a schematically simplified manner the basic principle of the proposed technical solution with a short-to-open converter StOC;

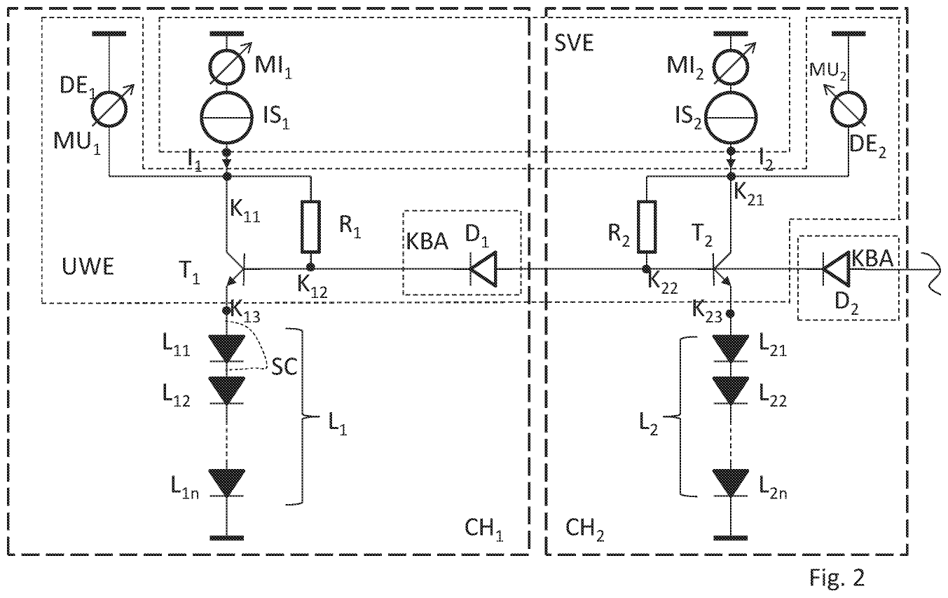

FIG. 2 shows a simple more specific example of the proposed solution with NPN bipolar transistors;

FIG. 3 shows a simple more specific example of the proposed solution with PNP bipolar transistors;

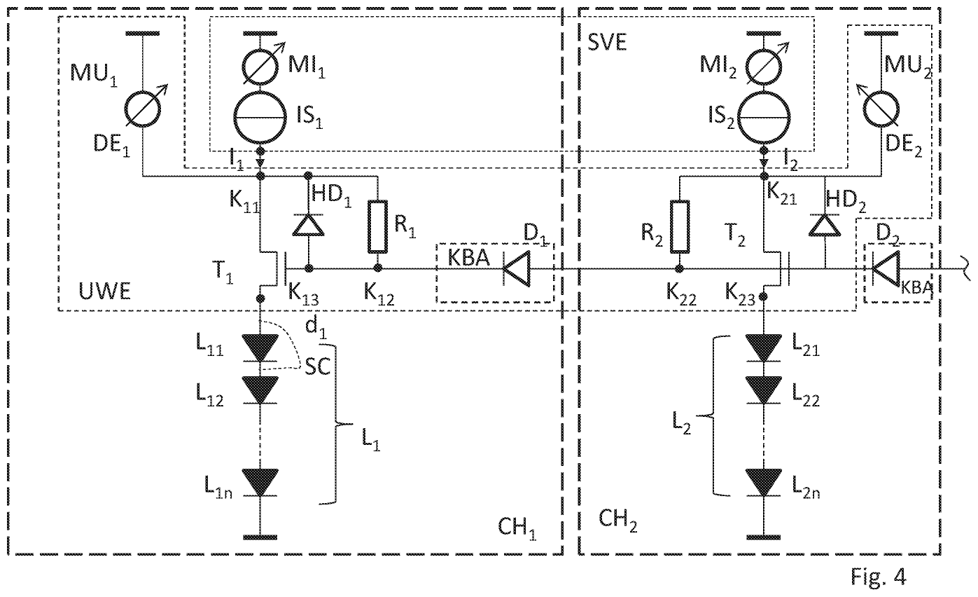

FIG. 4 shows a simple more specific example of the proposed solution with N-channel MOS transistors;

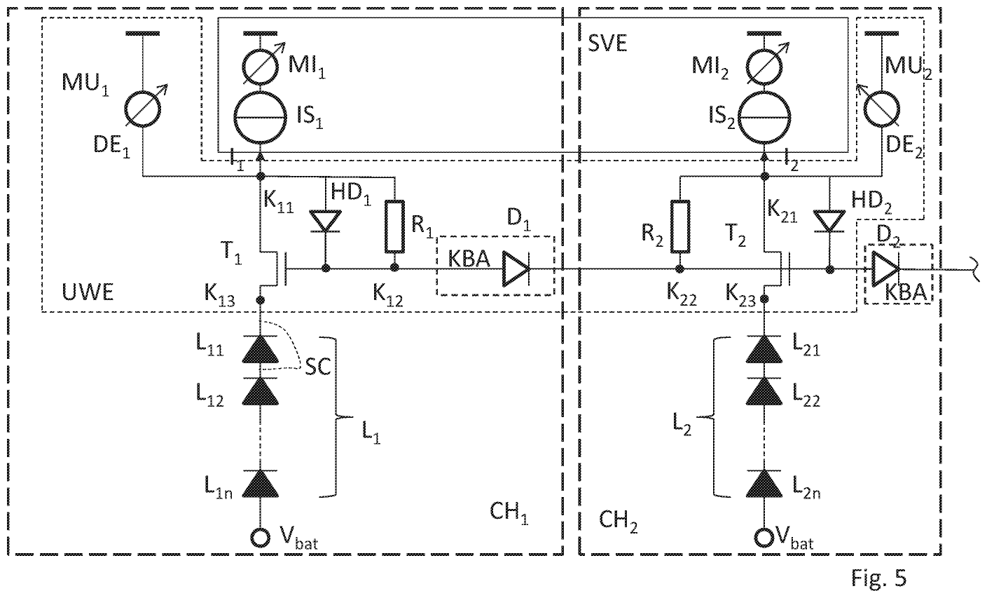

FIG. 5 shows a simple more specific example of the proposed solution with P-channel MOS transistors;

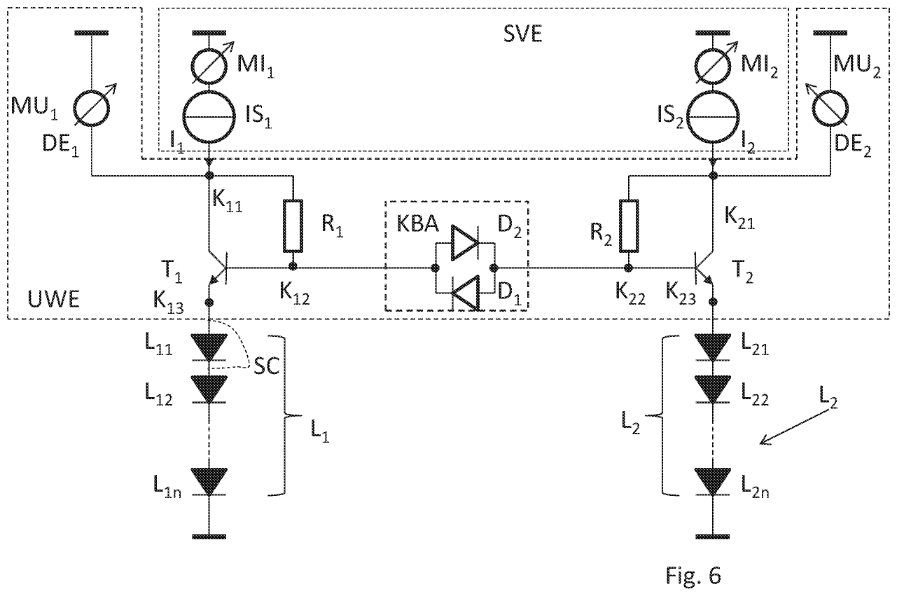

FIG. 6 shows a circuit assembly corresponding to that of FIG. 2 with the difference that the sub-device which forms the short-to-open converter StOC acts in both directions;

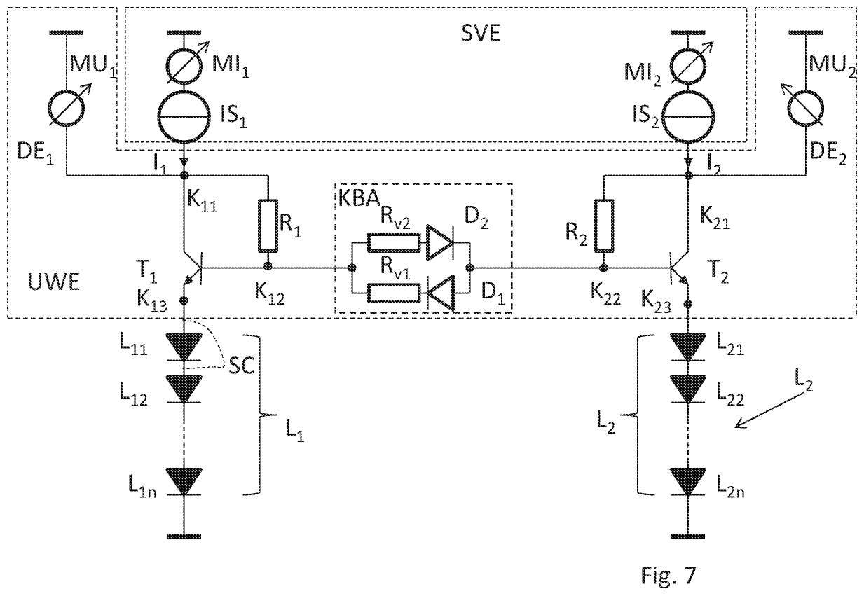

FIG. 7 shows a circuit assembly corresponding to that of FIG. 6 with the difference that an asymmetry of the LED chains can be compensated for by series resistors of the diodes;

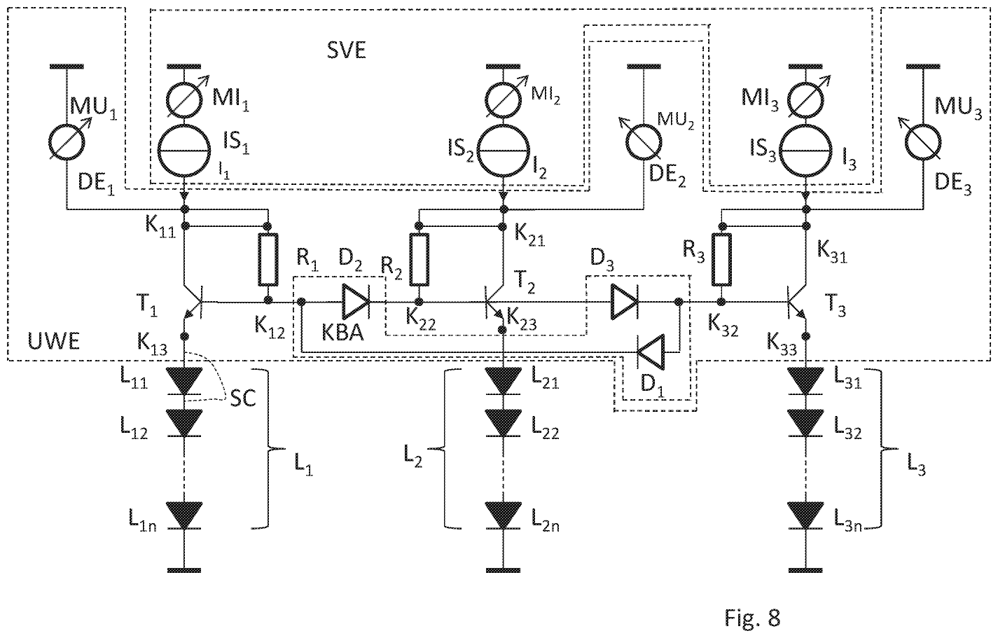

FIG. 8 shows a circuit assembly corresponding to a stringing together of a number of FIG. 2 in a ring; and

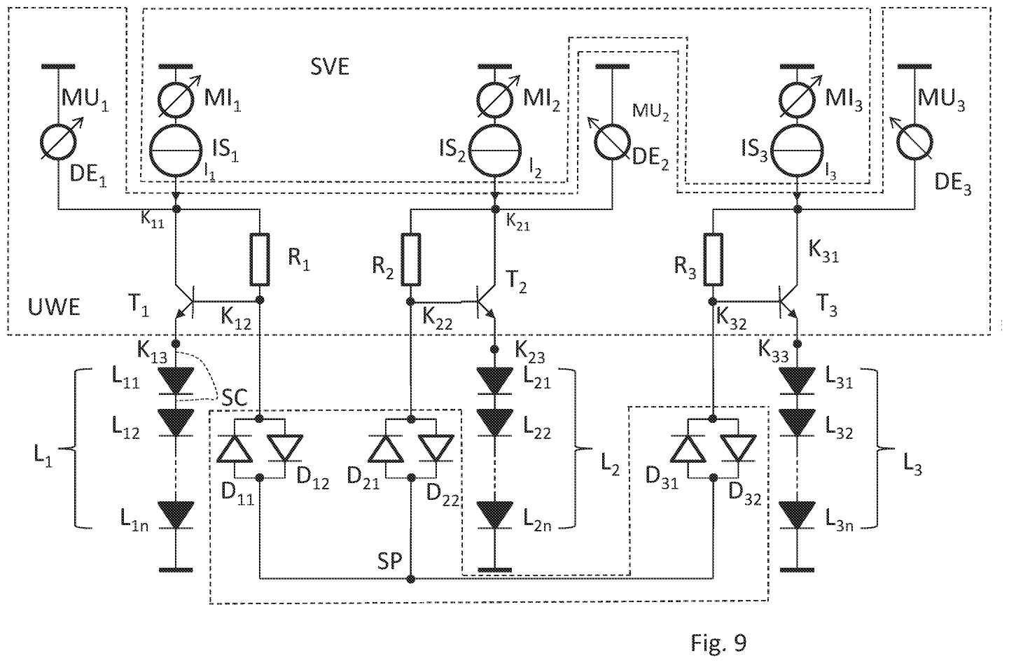

FIG. 9 shows a circuit assembly corresponding to the star-shaped interconnection of a number of FIG. 6.

FIG. 1 shows the primary concept of the solution of the proposed device and the proposed method. A first lighting channel CH₁ comprises the first power source—here the first current source IS₁—the first LED chain L₁ with the LEDs L₁₁,L₁₂, . . . , L₁ₙ and first measurement means MI₁,MU₁. The first channel, in this example, comprises a first current measurement means MI₁, which detects the value of the first electrical current I₁ fed into the first LED chain L₁ by the power source. A first detector DE₁ in the form of a first voltage measurement means MU₁ detects the voltage drop across the first LED chain L₁. The first channel CH₁ typically comprises at least one of these first measurement means: in other words, at least the first current measurement means MI₁ or the first voltage measurement means MU₁, so as to be able to detect an interruption to the first LED chain L₁. A second lighting channel CH₂ comprises the second power source—here the second current source IS₂—the second LED chain L₂ with the LEDs L₂₁,L₂₂, . . . , L₂ₙ and second measurement means MI₂,MU₂. The second channel CH₂ in this example comprises a second current measurement means MI₂, which detects the value of the second electrical current I₂ fed into the second LED chain L₂ by the second power source. A second voltage measurement means MU₂ detects, as detector DE₂, the voltage drop across the second LED chain L₂. The second channel CH₂ typically comprises at least one of these second measurement means: in other words the second current measurement means MI₂ or the second voltage measurement means MU₂ (detector D₂), so as to be able to detect an interruption of the second LED chain L₂.

Between the (multi-channel) current supply unit SVE and the LED chains L₁, L₂ there is arranged a monitoring device UWE, in which a short circuit of an LED or a few LEDs in one of the LED chains is “converted” in accordance with the disclosure into an interruption of another of the LED chains, which is identified by the detector associated with this interrupted LED chain. The monitoring device UWE thus has a short-to-open converter StOC, which connects one end of the first LED chain L₁ in normal operation electrically conductively to the first power source, here the first current source IS₁, and one end of the second LED chain L₂ in normal operation electrically conductively to the second power source, here the second current source IS₂. The short-to-open converter StOC particularly preferably evaluates the potential of the third node K₁₃ of the first lighting channel (CH₁) relative to a reference potential—preferably ground. Depending on the electrical potential of the third node K₁₃ of the first lighting channel CH₁ relative to the reference potential, the short-to-open converter StOC interrupts the electrical connection between the second power source, here the second current source IS₂, and the second LED chain L₂. The second measurement means, the second voltage measurement means MU₂ and/or the second current measurement means MI₂, i.e. the second detector DE₂, are hereby put in a position to detect this interruption and to provide a corresponding error signal. The short-to-open converter StOC particularly preferably acts symmetrically. In other words, if the voltage drop across the second LED chain L₂ changes beyond a certain extent, the short-to-open converter StOC separates the electrical connection between the first power source, here the first current source IS₁, and the first LED chain L₁ similarly. The first measurement means, the first voltage measurement means MU₁ and/or the first current measurement means MI₁, i.e. the first detector DE₁ are hereby similarly put in a position to detect this interruption and to provide a corresponding error signal.

FIG. 2 shows a simple realisation of this principle. Here, the first LED chain L₁ is monitored for short circuits of individual LEDs, whereas the second LED chain L₂ is used for signalling.

The structure of the part of the monitoring device UWE associated with the first channel CH₁ will be described first.

A first transistor T₁ (first interrupter switch) is in this example an NPN bipolar transistor. This is connected to its collector by means of a first node K₁₁ of the first channel CH₁. The first voltage measurement means MU₁ (first detector DE₁) and the first current source IS₁ as first power source are also optionally connected by means of this first node Ku of the first channel CH₁. The first current measurement means MI₁ optionally provided is connected in series with the first current source IS₁. The order of first current source IS₁ and first current measurement means MI₁ can be varied. The first node Ku of the first channel CH₁ is connected to the base of the first transistor T₁ by means of a first resistor R₁. The operating point of the first transistor T₁ is hereby set. The first resistor R₁ energises the base-emitter diode of the first transistor T₁, which is thus conductive in the normal state. The emitter of the first transistor T₁ at K₁₃ is connected to one end of the first LED chain L₁. This connection is the third electrical node K₁₃ of the first channel CH₁. The other end of the first LED chain L₁ is connected to the reference potential, here to ground. The base of the first transistor T₁ forms the second electrical node K₁₂ of the first channel CH₁.

The structure of the part of the monitoring device UWE associated with the second channel CH₂ will now be described.

A second transistor T₂ (second interrupter switch) is in this example likewise an NPN bipolar transistor. This is connected to its collector by means of a second node K₂₁ of the second channel CH₂. The second voltage measurement means MU₂ (second detector DE₂) and the second current source IS₂ as first power source are also optionally connected by means of this second node K₂₁ of the first channel CH₂. The second current measurement means MI₂ optionally provided is connected in series with the second current source IS₂. The order of second current source IS₂ and second current measurement means MI₂ can be varied. The first node K₂₁ of the second channel CH₂ is connected to the base of the second transistor T₂ by means of a second resistor R₂. The operating point of the second transistor T₂ is hereby set. The second resistor R₂ energises the base-emitter diode of the second transistor (T₂), which is thus conductive in the normal state. The emitter of the second transistor T₂ is connected to one end of the second LED chain L₂. This connection is the third electrical node K₂₃ of the second channel CH₂. The other end of the second LED chain L₂ is connected to the reference potential, here to ground. The base of the second transistor T₂ forms the second electrical node K₂₂ of the second channel CH₂.

The monitoring device UWE has, as coupling component assembly KBA connected between the base connections K₁₂, K₂₁ of the transistors T₁, T₂, a first diode D₁, which connects the base of the first transistor T₁, i.e. the second node K₁₂ of the first channel CH₁, to the base of the second transistor T₂, i.e. the second node K₂₂ of the second channel CH₂. The electrical connection between the second node K₁₂ of the first channel CH₁ and the second node K₂₂ of the second channel CH₂ is normally interrupted due to the diode D₁, since the voltage drop across the first LED chain L₁ and the second LED chain L₂ should be the same with the same energisation, and therefore the voltage difference across the diode D₁ causing a flow of current through the diode D₁ does not drop, i.e. the threshold voltage of the diode is not reached. Here, symmetrical conditions are firstly assumed. This means the same number n of LEDs in the two LED chains and the same first current I₁ and second current I₂. Due to the currents I₁,I₂ of the two current sources IS₁,IS₂ set to the same values, the same electrical potential is defined for the respective third nodes K₁₃,K₂₃ of the first channel CH₁ and the second channel CH₂ with the same LEDs and same LED number. If the resistance value of the first resistor R₁ is selected to be equal to the resistance value of the second resistor R₂, the base-emitter diode of the first transistor T₁ is energised with the same current as the base-emitter diode of the second transistor T₂. For the sake of simplicity, it is assumed here that the first transistor T₁ has properties that are the same as the properties of the second transistor T₂. Thus, identical base-emitter voltages drop across the base-emitter diode sections. In this case, in normal operation, the potential therefore must be the same on both sides of the first diode D₁, and no current flows. In reality none of the resistors R₁,R₂, the transistors T₁,T₂, or the LEDs of the LED chains L₁L₂ are identical, and instead differ from one another. It is therefore expedient to select the switching voltage of the first diode D₁ or the coupling component assembly KBA suitably. Zener diodes may be used optionally, or series connections of diodes. In some cases it may be expedient, instead of silicon diodes, to use germanium diodes or other diodes modified suitably in respect of their switching voltage by suitable materials. In any case it should be clarified, by means of a (for example Monte Carlo) simulation, which diode switching voltages require the scattering of the components. This is different, however, depending on the application and therefore will not be discussed here in further detail.

In the case of a short circuit of an individual LED (FIG. 2 by way of example shows a short circuit SC of the first LED L₁₁ of the first LED chain L₁) the flow of current through the first LED chain L₁ remains at the current value of the first current I₁ of the first current source IS₁. The potential of the third node K₁₃ of the first channel CH₁ relative to the reference potential drops by an LED switching voltage, i.e. by the voltage that drops across each of the preferably identical LEDs when current is first passed through them. So that the value of the potential of the second node K₁₂ of the first channel CH₁ relative to ground thus also decreases by exactly this value, it is coupled by the enforced fixed voltage drop across the base-emitter diode of the first transistor T₁ to the potential of the third node K₁₃ of the first channel. There is thus a (increased) voltage difference between the second node K₂₂ of the second channel CH₂ and the second node K₁₂ of the first channel CH₁ and therefore a (increased) voltage difference over the coupling component assembly KBA. This voltage difference is in the flow direction of the first diode D₁. With a suitable selection of the switching voltage of the coupling component assembly KBA (first diode D₁), this starts to become conductive. The switching voltage of the first diode D₁ should therefore be less than or equal to the switching voltages of the used LEDs in the first LED chain L₁. It preferably lies between 5% and 90% lower than the switching voltage of the LEDs. The first diode can optionally also be replaced by an electrical circuit of identical effect with amplifiers, etc., which shows a suitable switching voltage. If reference is thus made here to the first diode D₁, this relates to the effect of this component or a circuit replacing this component, i.e. to any kind of coupling component assembly KBA, which is conductive from a predefined switching voltage.

If the first diode D₁ now opens, the current that previously was drained off through the base-emitter diode of the second transistor T₂ thus drains off across the base-emitter diode of the first transistor T₁. The second transistor is thus less conductive, whereby the potential of the third node K₂₃ of the second channel CH₂ decreases. Due to the great amplification of the current and the great differential resistance of the LEDs of the second LED chain L₂, the second LED chain L₂ is switched off (T₂ opens). The current reduction of the current of the second current source IS₂ hereby decreases, and this can be detected by the second measurement means MI₂,MU₂ (detector DE₂). Due to this detection, an interruption is then typically detected and optionally signalled.

The remaining second diode D₂ of the second channel CH₂ is used only to clarify a potential connection possibility (coupling in each case of two LED chains where multiple LED chains are provided).

### Example Calculation

On the exemplary assumption that the forward voltage of an LED is 3V, the potential of the third node K₁₃ of the first channel CH₁ is n*3V. It is assumed by way of example that n=5 for the calculation. Thus, 15 V drop across the first LED chain L₁ between the third node K₁₃ of the first channel and ground. 0.7 V for example will drop across the base-emitter diode of the first transistor T₁. The potential of the second node K₁₂ of the first channel CH₁ in normal operation thus lies at 15.7 V against ground potential. The same is true similarly for the potential of the second node K₂₂ of the second channel CH₂ in normal operation, which thus lies likewise at 15.7 V against ground potential. If the first LED L₁₁ is now short-circuited by a short circuit SC, the potential of the third node K₁₃ of the first channel CH₁ thus drops by an LED switching voltage=3 V. It is thus at 12 V. It follows that the potential of the second node K₁₂ of the first channel CH₁ then lies only at 12.7 V. 15.7 V-12.7 V=a drop of 3 V, i.e. an LED threshold voltage across the first diode D₁, whereupon this starts to become conductive because its threshold voltage, i.e. the switching voltage of the, generally expressed, coupling component assembly KBA in this example lies at 0.7 V. The potential of the second node K₂₂ of the second channel, however, is then determined by the voltage drop across the first diode D₁. If the switching voltage thereof is again for example 0.7 V, the potential of the second node K₂₂ of the second channel CH₂ is thus merely 13.4 V instead of 15.7 V. The potential of the third node K₂₃ of the second channel CH₂ hereby must lie 0.7 V lower in accordance with the base-emitter voltage of the second transistor T₂ at 12.7 V. Due to the steep characteristic curve of the LEDs in the second LED chain L₂, the current reduction at the second current source IS₂ thus decreases. This can be detected by the second measurement means MI₂, MU₂ (detector DE₂). This reduction of the second current I₂ can be detected directly by the second current measurement means MI₂ or as a changing voltage drop across the second current source IS₂. The conditions correspond to an interruption of the second LED chain L₂ and are identified as such by the second measurement means of the second channel CH₂.

FIG. 3 corresponds substantially to FIG. 2. The LED chains, however, are connected to the supply voltage “in reverse”. The supply voltage V_{bat} is now used as a reference potential. The first transistor T₁ and the second transistor T₂ are now PNP transistors by way of example. The first diode D₁ is likewise rotated in order to produce functional capability. The operating principle, however, is otherwise similar to that of FIG. 2.

FIG. 4 corresponds to FIG. 2, with the difference that N-channel MOS transistors are used instead of the NPN bipolar transistors for the first transistor T₁ and the second transistor T₂. In order to couple the second node K₁₂ of the first channel CH₁ to the third node K₁₃ of the first channel in respect of the voltage difference between these two nodes, the function of the omitted base-emitter diode must be replaced. This is achieved by a first auxiliary diode HD₁. The flow of current across the first auxiliary diode HD₁ is adjusted via the first resistor R₁, such that the first auxiliary diode is open in normal operation. The first transistor T₁ is preferably installed such that the source of the first transistor T₁ is connected to the third node K₁₃ of the first channel CH₁.

FIG. 5 corresponds to FIG. 3, with the difference that P-channel MOS transistors are used instead of the PNP bipolar transistors for the first transistor T₁ and the second transistor T₂. In order to couple the second node K₁₂ of the first channel CH₁ to the third node K₁₃ of the first channel in respect of the voltage difference between these two nodes, the function of the omitted base-emitter diode must be replaced. This is achieved by a first auxiliary diode HD₁. The flow of current across the first auxiliary diode HD₁ is adjusted via the first resistor R₁, such that the first auxiliary diode is open in normal operation. The first transistor T₁ is preferably installed such that the source of the first transistor T₁ is connected to the third node K₁₃ of the first channel CH₁.

FIG. 6 corresponds to FIG. 2, with the difference that the coupling component assembly KBA has a second diode D₂, which is connected anti-parallel relative to the first diode D₁. The second channel CH₂ in the event of a short circuit to an individual LED in the second LED chain L₂ can now hereby also interrupt the flow of current in the first channel CH₁ and thus bring about the detection of an interruption in the LED chains via the first channel CH₁. FIG. 7 corresponds to FIG. 6, with the difference that the first diode D₁ and the second diode D₂ of the coupling component assembly KBA are each provided with a series resistor Rᵥ₁, Rᵥ₂. These series resistors make it possible to make the circuit asymmetrical. This is necessary in particular if the LED chains are different or the nominal currents I₁, I₂ are unequal already in normal operation. The possibility of replacing the first diode D₁ and/or the second diode D₂ by more complex circuits of equivalent effect has already been discussed above. In reality it may be expedient if the first diode D₁ has a different switching voltage as compared to the second diode D₂.

FIG. 8 corresponds to FIG. 2, in which three LED chains L₁, L₂, L₃ are used in three channels. The coupling component assembly KBA has three diodes D₁, D₂, D₃, which are connected in a triangle, i.e. as a ring circuit, such that a flow of current in a ring—across the first diode D₁, then across the second diode D₂, then across the third diode D₃, and then again across the first diode D₁—is possible. The principle can be extended to a positive integer k of channels CH₁ to CHₖ accordingly. All LED chains of any number k of LED chains are hereby monitored for short circuits of individual LEDs.

FIG. 9 shows a coupling component assembly KBA for the connection in a star shape of three channels for three LED chains L₁, L₂, L₃. Each two of the channels correspond here to the circuit according to FIG. 6, with the difference that the first diode D₁ and the second diode D₂ of FIG. 6 are now formed by four diodes (for example D₁₁, D₁₂ and D₂₁ und D₂₂). Since two diode voltages now drop across the first diode D₁ and second diode D₂ thus replaced, it may be expedient to replace the diodes D₁₁, D₁₂, D₂₁, D₂₂, D₃₁, D₃₂ with diodes having an accordingly reduced switching voltage or corresponding circuits of identical function.

The disclosure may also be described alternatively by one of the following groups of features, wherein the groups of features can be combined arbitrarily with one another and individual features of a group of features also can be combined with one or more features of one or more other groups of features and/or one or more of the previously described examples.

1. A device for supplying at least two LED chains L₁,L₂, L₃ with electricity with the possibility of detecting and then signalling an interruption in the current path within one of these at least two LED chains L₁, L₂, L₃, wherein said device comprises a sub-device StOC which, when one LED or a number of LEDS within a first LED chain is/are short-circuited, brings about a detection and/or subsequent signalling of an interruption of the current path within another LED chain of these at least two LED chains L₁, L₂, L₃, hereinafter the second LED chain.

2. The device according to number 1,
wherein a transistor T₁, T₂, T₃, in particular a bipolar transistor or a MOS transistor, with a control connection (base or gate) and two further connections is disposed in each current path of each LED chain of these at least two LED chains L₁, L₂, L₃,
wherein each transistor T₁, T₂, T₃ is part of the sub-device, and
wherein each transistor T₁, T₂, T₃ is conductive in fault-free operation, and
wherein at least one transistor T₁, T₂ T₃ of the second LED chain of the at least two LED chains L₁, L₂, L₃, referred to hereinafter as the second transistor, is switched to be blocking if, in a first LED chain of the at least two LED chains L₁, L₂, L₃, a short circuit (SC) occurs along the LED chain.

3. The device according to either one of the preceding numbers,
wherein the at least one transistor of the first LED chain of the at least two LED chains L₁, L₂, L₃, referred to hereinafter as the first transistor, is a bipolar transistor T₁, T₂, T₃ or a MOS transistor T₁, T₂, T₃ and
wherein the at least one second transistor of the second LED chain of the at least two LED chains L₁, L₂, L₃ is a bipolar transistor T₁, T₂, T₃ or a MOS transistor T₁, T₂, T₃, and
wherein the control connection (base or gate) of the first transistor is connected to the control connection (base or gate) of the second transistor via at least one diode D₁, D₂, D₃, D₁₁, D₁₂, D₂₁, D₂₂, D₃₁, D₃₂ directly or indirectly, in particular via a series resistor Rᵥ₁, Rᵥ₂, and
wherein the control connection (base or gate) of the first transistor is energised by means of an operating point setting, in particular such that the control connection (base or gate) of the first transistor is connected via an operating point resistor R₁, R₂, R₃ to the power source IS₁, IS₂, IS₃ of the first LED chain in the current path of which the first transistor is disposed,
wherein in the case of a MOS transistor as first transistor the control connection (base or gate) of the first transistor is connected to a connection of the first LED chain via a first auxiliary diode, and
wherein in the case of a MOS transistor as second transistor the control connection (base or gate) of the second transistor is connected to a connection of the second LED chain via a second auxiliary diode.

4. The device according to any one of the preceding numbers,
wherein the device has at least three LED chains L₁, L₂, L₃ and
wherein a transistor T₁, T₂, T₃, in particular a bipolar transistor, is disposed in each current path of each LED chain of these at least three LED chains L₁, L₂, L₃,
wherein each transistor T₁, T₂, T₃ is part of the sub-device and
wherein each transistor T₁, T₂, T₃ is conductive in fault-free operation, and
wherein at least one of these transistors T₁, T₂, T₃, hereinafter referred to as the transistor switched to be blocking, is connected to be blocking if, in at least one other LED chain of the at least three LED chains L₁, L₂, L₃, which is not the LED chain of the transistor switched to be blocking, a short circuit occurs along the other LED chain, and
wherein the control connection (base or gate) of each transistor of a preceding LED chain is connected to the control connection (base or gate) of the following transistor of a following LED chain via at least one diode D₁, D₂, D₃, D₁₁, D₁₂, D₂₁, D₂₂, D₃₁, D₃₂ directly or indirectly, in particular via a series resistor Rᵥ₁, Rᵥ₂, Rᵥ₃, and
wherein the control connection (base or gate) of the preceding transistor is energised by means of an operating point setting, in particular wherein the control connection (the base or the gate) of the preceding transistor is connected via an operating point resistor R₁, R₂, R₃ to the power source IS₁, IS₂, IS₃ of the associated LED chain in the current path of which the preceding transistor is disposed, and
wherein, in the case of a MOS transistor as following transistor, the control connection (base or gate) of the following transistor is connected to a connection of the following LED chain, to which it is connected, via an associated following auxiliary diode, and
wherein, in the case of a MOS transistor as preceding transistor, the control connection (base or gate) of the preceding transistor is connected to a connection of the preceding LED chain, to which it is connected, via an associated preceding auxiliary diode, and
wherein the diodes are connected in a ring, such that they would enable a flow of current through the diodes in a ring in one direction.

5. The device according to any one of the preceding numbers,
wherein the device comprises at least three LED chains L₁, L₂, L₃, and
wherein a transistor T₁, T₂, T₃, in particular a bipolar transistor or a MOS transistor, is disposed in each current path of each LED chain of these three LED chains L₁, L₂, L₃,
wherein each transistor T₁, T₂, T₃ is part of the sub-device and
wherein each transistor T₁, T₂, T₃ is conductive in fault-free operation, and
wherein always at least one of these transistors T₁, T₂, T₃ is switched to be blocking if a short circuit occurs in at least one other LED chain of the at least three LED chains L₁, L₂, L₃ which is not the LED chain of the transistor switched to be blocking, and
wherein the control connection (base or gate) of each transistor of a preceding LED chain is connected to the control connection (base or gate) of the following transistor via at least two diode pairs D₁₁, D₁₂; D₂₁, D₂₂; D₃₁, D₃₂ connected one after the other in series and formed in each case of two diodes D₁₁, D₁₂; D₂₁, D₂₂; D₃₁, D₃₂ connected anti-parallel,
   wherein the diodes have two connections and
   wherein each diode can be connected in series with a resistor, and
wherein the control connection (base or gate) of the preceding transistor is energised by means of an operating point setting, in particular
   wherein the control connection (base or gate) of the preceding transistor is connected via an operating point resistor R₁, R₂, R₃ to the power source IS₁, IS₂, IS₃ of the associated LED chain in the current path of which the preceding transistor is disposed, and
wherein in the case of a MOS transistor as following transistor the control connection (base or gate) of the following transistor is connected to a connection of the following LED chain, to which it is connected, via an associated following auxiliary diode, and
wherein in the case of a MOS transistor as preceding transistor, the control connection (bass or gate) of the preceding transistor is connected to a connection of the preceding LED chain, to which it is connected, via an associated preceding auxiliary diode, and
wherein the diodes are connected such that they are connected by means of a connection to a common star point SP.

6. A device for supplying at least two LED chains L₁, L₁₂, . . . L₁ₙ; L₂₁, L₂₂, . . . L₂ₙ; L₃₁, L₃₂, . . . L₃ₙ with electricity, with the possibility of detecting and then signalling an interruption of the current path within one of these at least two LED chains L₁₁, L₁₂, . . . L₁ₙ; L₂₁, L₂₂, . . . L₂ₙ; L₃₁, L₃₂, . . . L₃ₙ, wherein the device comprises a sub-device StOC which, when one LED or a number of LEDS within a first LED chain of the at least LED chains L₁₁, L₁₂, . . . L₁ₙ; L₂₁, L₂₂, . . . , L₂ₙ; L₃₁, L₃₂, . . . L₃ₙ is/are short-circuited, performs a detection, and wherein the sub-device StOC brings about a signalling of this detected short circuit by means of an interruption of the current path within another LED chain of these at least two LED chains L₁₁, L₁₂, . . . L₁ₙ; L₂₁, L₂₂ . . . L₂ₙ; L₃₁, L₃₂, . . . L₃ₙ, hereinafter the second LED chain.

7. The device according to any one of the preceding numbers,
wherein a transistor T₁, T₂, T₃, in particular a bipolar transistor or a MOS transistor, with a control connection (base) and two further connections is disposed in each current path of each LED chain of these at least two LED chains L₁₁, L₁₂, . . . L₁ₙ; L₂₁, L₂₂, . . . L₂ₙ; L₃₁, L₃₂, . . . L₃ₙ,
wherein each transistor T₁, T₂, T₃ is part of the sub-device, and
wherein each transistor T₁, T₂, T₃ is conductive in fault-free operation, and
wherein at least one transistor T₁, T₂, T₃ of the second LED chain of the at least two LED chains L₁₁, L₁₂, . . . L₁ₙ; L₂₁, L₂₂, . . . L₂ₙ; L₃₁, L₃₂, . . . L₃ₙ, referred to hereinafter as the second transistor, is switched to be blocking if, in a first LED chain of the at least two LED chains L₁₁, L₁₂, . . . L₁ₙ; L₂₁, L₂₂, . . . L₂ₙ; L₃₁, L₃₂, . . . L₃ₙ, a short circuit (SC) occurs along the LED chain.

8. The device according to any one of the preceding numbers,
wherein the at least one transistor of the first LED chain of the at least two LED chains L₁₁, L₁₂, . . . L₁ₙ; L₂₁, L₂₂, . . . L₂ₙ; L₃₁, L₃₂, . . . L₃ₙ, referred to hereinafter as the first transistor, is a bipolar transistor T₁, T₂, T₃ or a MOS transistor T₁, T₂, T₃, and
wherein the at least one second transistor of the second LED chain of the at least two LED chains L₁₁, L₁₂, . . . L₁ₙ; L₂₁, L₂₂, . . . L₂ₙ; L₃₁, L₃₂, . . . L₃ₙ is a bipolar transistor T₁, T₂, T₃ or a MOS transistor T₁, T₂, T₃, and
wherein the control connection (base) of the first transistor is connected to the control connection (base or gate) of the second transistor via at least one diode D₁, D₂, D₃, D₁₁, D₁₂, D₂₁, D₂₂, D₃₁, D₃₂ directly or indirectly, in particular via a series resistor Rᵥ₁, Rᵥ₂, and
wherein the control connection (base) of the first transistor is energised by means of an operating point setting, in particular such that the control connection (base or gate) of the first transistor is connected via an operating point resistor R₁, R₂, R₃ to the power source IS₁, IS₂, IS₃ of the first LED chain in the current path of which the first transistor is disposed.

9. The device according to any one of the preceding numbers,
wherein the device has at least three LED chains L₁, L₁₂, . . . L₁ₙ; L₂₁, L₂₂, . . . L₂ₙ; L₃₁, L₃₂, . . . L₃ₙ, and
wherein a transistor T₁, T₂, T₃, in particular a bipolar transistor, is disposed in each current path of each LED chain of these at least three LED chains L₁, L₁₂, . . . L₁ₙ; L₂₁, L₂₂, . . . L₂ₙ; L₃₁, L₃₂, . . . L₃ₙ,
wherein each transistor T₁, T₂, T₃ is part of the sub-device and
wherein each transistor T₁, T₂, T₃ is conductive in fault-free operation, and
wherein at least one of these transistors T₁, T₂, T₃, hereinafter referred to as the transistor switched to be blocking, is switched to be blocking if, in at least one other LED chain of the at least three LED chains L₁₁, L₁₂, . . . L₁ₙ; L₂₁, L₂₂, . . . L₂ₙ; L₃₁, L₃₂, . . . L₃ₙ which is not the LED chain of the transistor switched to be blocking, a short circuit occurs along the LED chain in question, and
wherein the control connection (base) of each transistor of a preceding LED chain is connected to the control connection (base) of the following transistor of a following LED chain via at least one diode D₁, D₂, D₃, D₁₁, D₁₂, D₂₁, D₂₂, D₃₁, D₃₂ directly or indirectly, in particular via a resistor Rᵥ₁, Rᵥ₂, Rᵥ₃, and
wherein the control connection (base) of the preceding transistor is energised by means of an operating point setting, in particular wherein the control connection (the base or the gate) of the preceding transistor is connected via an operating point resistor R₁, R₂, R₃ to the power source IS₁, IS₂, IS₃ of the associated LED chain in the current path of which the preceding transistor is disposed, and
wherein the diodes are connected in a ring, such that they would enable a flow of current through the diodes in a ring in one direction.

10. The device according to any one of the preceding numbers,
wherein the device has at least three LED chains L₁₁, L₁₂, . . . L₁ₙ; L₂₁, L₂₂, . . . L₂ₙ; L₃₁, L₃₂, . . . L₃ₙ and
wherein a transistor T₁, T₂, T₃, in particular a bipolar transistor or a MOS transistor, is disposed in each current path of each LED chain of these three LED chains L₁, L₁₂, . . . L₁ₙ; L₂₁, L₂₂, . . . L₂ₙ; L₃₁, L₃₂, . . . L₃ₙ,
wherein each transistor T₁, T₂, T₃ is part of the sub-device, and
wherein each transistor T₁, T₂, T₃ is conductive in fault-free operation, and
wherein at least one of these transistors T₁, T₂, T₃ is always switched to be blocking if, in at least one other LED chain of the at least three LED chains L₁, L₁₂, . . . L₁ₙ; L₂₁, L₂₂, . . . L₂ₙ; L₃₁, L₃₂, . . . L₃ₙ which is not the LED chain of the transistor switched to be blocking, a short circuit occurs, and
wherein the control connection (base) of each transistor of a preceding LED chain is connected to the control connection (base) of the following transistor via at least two diode pairs D₁₁, D₁₂; D₂₁, D₂₂; D₃₁, D₃₂ connected one after the other in series and formed in each case of two diodes D₁₁, D₁₂; D₂₁, D₂₂; D₃₁, D₃₂ connected anti-parallel,
   wherein the diodes have two connections, and
   wherein each diode can be connected in series with a resistor, and
wherein the control connection (base) of the preceding transistor is energised by means of an operating point setting, in particular
   wherein the control connection (base) of the preceding transistor is connected via an operating point resistor R₁, R₂, R₃ to the power source IS₁, IS₂, IS₃ of the associated LED chain in the current path of which the preceding transistor is disposed, and
wherein the diodes are connected such that they are connected by means of a connection to a common star point SP.

11. The device according to any one of the preceding numbers,
wherein the device comprises measurement means MI₁, MU₁; MI₂, MU₂; MI₃, MU₃ for detecting the interruption of the second LED chain, and
wherein the device comprises suitable signalling means so as to be able to signal the detection result of the measurement means MI₁, MU₁; MI₂, MU₂; MI₃, MU₃ to a control device.

12. A method for detecting an individual LED failure in a lighting device comprising at least two LED chains L₁, L₂, L₃, said method comprising the following steps:
detecting an individual LED short circuit in a first LED chain of the at least two LED chains L₁, L₂, L₃ by a first detection means (for example first transistor T₁ and first diode D₁ in cooperation with first resistor R₁ in FIG. 3) and interrupting, as a result of this detection, the flow of current through at least one other LED chain of the at least two LED chains L₁, L₂, L₃ by an interruption means (for example transistor T₂ in FIG. 3),
detecting the interruption of the flow of current through the other LED chain of the at least two LED chains L₁, L₂, L₃.

### Glossary

### LED

An LED in the sense of this disclosure is not only an individual light-emitting diode, but may also be a series and/or parallel circuit of multiple light-emitting diodes, which optionally also comprises further components, such as Zener diodes and/or series resistors and parallel resistors and capacitors. The circuits are typically bipolar circuits with a first connection, which serves as current input, and a second connection, which serves as current output. If the LEDs in an LED chain are connected to one another in series, it is thus conceivable that, between the LEDs, further lines are guided fully or partially along the LED chain, for example as control line for other purposes not claimed here, but are not intended to limit the claimed scope merely to individual bipolar light-emitting diodes. The LED chains are preferably of equal length, that is to say preferably contain the same number of LEDs with preferably identical diode switching voltages (U_{D}).

### LED Chain

An LED chain in the sense of this disclose is a series circuit formed of at least two LEDs, which are all oriented identically, such that a flow of current is possible.

### Switching Voltage

In the sense of this disclosure the switching voltage of a diode, auxiliary diode or LED is the voltage at which the diode, auxiliary diode or LED starts to become conductive. With regard to the coupling component assembly, the switching voltage determines the greatest voltage drop across the coupling component assembly at which this is connected through.

### LIST OF REFERENCE SIGNS

CH₁ first channel. The first channel comprises the first power source—here the first current source IS₁—the first LED chain L₁, the first transistor T₁, the first resistor R₁, the first diode D₁, and first measurement means MI₁,MU₁. The first transistor T₁ is connected in series with the first LED chain L₁ at the third node K₁₃ of the first channel, and at the first node Ku of the first channel is connected to the first power source, here the first current source IS₁, and optionally to a first voltage measurement means MU₁ and the first resistor R₁. The first resistor R₁ is connected to the third node K₁₃ of the first channel, which establishes the connection to the control connection of the first transistor T₁ and to a first connection of the first diode D₁. This first diode is then connected by means of its second connection to the corresponding control connection of the transistor of a following channel. In this regard it is particularly advantageous in various examples if the third node K₁₃ of the first channel also establishes a connection to the second connection of the diode of the following channel or a preceding channel. In addition, the first channel may comprise a first current measurement means MI₁, which detects the value of the first electrical current I₁ output by the power source. The first channel typically comprises at least one of these first measurement means, i.e. at least the first current measurement means MI₁ or the first voltage measurement means MU₁, so as to be able to detect an interruption of the first LED chain L₁.
CH₂ second channel. The second channel comprises the second power source—here the second current source IS₂—the second LED chain L₂, the second transistor T₂, the second resistor R₂, the second diode D₂, and second measurement means MI₂, MU₂. The second transistor T₂ is connected in series with the second LED chain L₂ at the third node K₂₃ of the second channel, and at the second node K₂₁ of the second channel is connected to the second power source, here the second current source IS₂, and optionally to a second voltage measurement means MU₂ and the second resistor R₂. The second resistor R₂ is connected to the second node K₂₃ of the second channel, which establishes the connection to the control connection of the second transistor T₂ and to a second connection of the second diode D₂. This second diode is then connected by means of its second connection to the corresponding control connection of the transistor of a following channel. In this regard it is particularly advantageous in various examples if the second node K₂₃ of the second channel also establishes a connection to the second connection of the diode of the following channel or a preceding channel. In addition, the second channel may comprise a second current measurement means MI₂, which detects the value of the second electrical current I₂ output by the power source. The second channel typically comprises at least one of these second measurement means, i.e. at least the second current measurement means (MI₂) or the second voltage measurement means MU₂, so as to be able to detect an interruption of the second LED chain L₂.
CH₃ third channel. The third channel comprises the third power source—here the third current source IS₃— the third LED chain L₃, the third transistor T₃, the third resistor R₃, the third diode D₃, and third measurement means MI₃, MU₃. The third transistor T₃ is connected in series with the third LED chain L₃ at the third node K₃₃ of the third channel, and at the first node K₃₁ of the third channel is connected to the third power source, here the third current source IS₃, and optionally to a third voltage measurement means MU₃ and the third resistor R₃. The third resistor R₃ is connected to the third node K₃₃ of the third channel, which establishes the connection to the control connection of the third transistor T₃ and to a first connection of the third diode D₃. This third diode is then connected by means of its second connection to the corresponding control connection of the transistor of a following channel. In this regard it is particularly advantageous in various examples if the third node K₃₃ of the third channel also establishes a connection to the second connection of the diode of the following channel or a preceding channel. In addition, the third channel may comprise a third current measurement means MI₃, which detects the value of the third electrical current I₃ output by the power source. The third channel typically comprises at least one of these third measurement means, i.e. at least the third current measurement means MI₃ or the third voltage measurement means MU₃, so as to be able to detect an interruption of the third LED chain L₃.
D₁ first diode of the first channel CH₁
D₂ second diode of the second channel CH₂
D₃ third diode of the third channel CH₃
D₁₁ first forward diode of the first channel CH₁
D₁₂ first reverse diode of the first channel CH₁
D₂₁ first forward diode of the second channel CH₂
D₂₂ first reverse diode of the second channel CH₂
D₃₁ first forward diode of the third channel CH₃
D₃₂ first reverse diode of the third channel CH₃
DE₁ first detector
DE₂ second detector
DE₃ third detector
DU diode switching voltage (This is the diode voltage at which the flow of current starts)
HD₁ first auxiliary diode of the first channel CH₁. The first auxiliary diode is necessary as detection device if, instead of a bipolar transistor, a MOS transistor is used as first transistor T₁. The first auxiliary diode then emulates the function of the base-emitter diode as detection device and forces the potential of a transistor of another channel to a potential at which the gate-source section no longer has sufficient voltage, whereby this starts to block if there is a short circuit of an individual LED or a plurality of LEDs along the LED chain in question. With the use of MOS transistors the functions of a detection device (first auxiliary device) and interruption device first transistor T₁) are thus separated, whereas in bipolar transistors they can be carried out simultaneously by the bipolar transistors (first transistor T₁ alone). With use of a bipolar transistor as first transistor T₁ the first auxiliary diode HD₁ therefore is not absolutely necessary.
HD₂ second auxiliary diode of the second channel CH₂. The second auxiliary diode is necessary as detection device if, instead of a bipolar transistor, a MOS transistor is used as second transistor T₂. The second auxiliary diode then emulates the function of the base-emitter diode as detection device and forces the potential of a transistor of another channel to a potential at which the gate-source section no longer has sufficient voltage, whereby this starts to block if there is a short circuit of an individual LED or a plurality of LEDs along the LED chain in question. With the use of MOS transistors the functions of a detection device (second auxiliary device) and interruption device second transistor T₂) are thus separated, whereas in bipolar transistors they can be carried out simultaneously by the bipolar transistors (second transistor T₂ alone). With use of a bipolar transistor as second transistor T₂ the second auxiliary diode HD₁ therefore is not absolutely necessary.
HD₃ third auxiliary diode of the third channel CH₃. The third auxiliary diode is necessary as detection device if, instead of a bipolar transistor, a MOS transistor is used as third transistor T₃. The third auxiliary diode then emulates the function of the base-emitter diode as detection device and forces the potential of a transistor of another channel to a potential at which the gate-source section no longer has sufficient voltage, whereby this starts to block if there is a short circuit of an individual LED or a plurality of LEDs along the LED chain in question. With the use of MOS transistors the functions of a detection device (third auxiliary device) and interruption device (third transistor T₃) are thus separated, whereas in bipolar transistors they can be carried out simultaneously by the bipolar transistors (third transistor T₃ alone). With use of a bipolar transistor as third transistor T₃ the third auxiliary diode therefore is not absolutely necessary.
I₁ first electrical current, which is fed into the first LED chain L₁ from the first power source—here the first current source IS₁—and supplies this with electricity.
I₂ second electrical current, which is fed into the second LED chain L₂ from the second power source—here the second current source IS₂—and supplies this with electricity.
I₃ third electrical current, which is fed into the third LED chain L₃ from the third power source—here the third current source IS₃— and supplies this with electricity.
IS₁ first current source as first power source of the first channel CH₁
IS₂ second current source as second power source of the second channel CH₂
IS₃ third current source as third power source of the third channel CH₃ Ku first node of the first channel CH₁. The first node of the first channel CH₁ connects the first power source, here the first current source IS₁, to the first transistor T₁ and the first resistor R₁, and a first voltage measurement means MU₁ for detecting the voltage drop across the first power source, here the first current source IS₁.
K₁₂ second node of the first channel CH₁. The second node of the first channel CH₁ connects the control connection of the first transistor T₁ to the first resistor R₁ and the first diode D₁. In the case of an NPN bipolar transistor as first transistor T₁ the connection of the first diode D₁ is the cathode thereof (FIG. 2). In the case of a PNP bipolar transistor as first transistor T₁ it is the anode (FIG. 3). If the first transistor T₁ is a MOS transistor, the second node of the first channel CH₁ may also be connected to a first auxiliary diode HD₁, which is connected to a third node K₁₃ of the first channel CH₁ and the orientation of which likewise conforms with the transistor type of the first transistor T₁.
K₁₃ third node of the first channel CH₁. The third node of the first channel CH₁ connects the first transistor T₁ to a first connection of the first LED chain L₁. It likewise optionally connects this to the second connection of a first auxiliary diode HD₁. This is helpful in particular if the first transistor T₁ is a MOS transistor. The orientation of the first auxiliary diode HD₁ then again conforms with the transistor type (P-channel MOS transistor or N-channel MOS transistor) of the first transistor T₁.
K₂₁ first node of the second channel CH₂. The first node of the second channel CH₂ connects the second power source, here the second current source IS₂, to the second transistor T₂ and the second resistor R₂, and a second voltage measurement means MU₂ for detecting the voltage drop across the second power source, here the second current source IS₂.
K₂₂ second node of the second channel CH₂. The second node of the second channel CH₂ connects the control connection of the second transistor T₂ to the second resistor R₂ and the second diode D₂. In the case of an NPN bipolar transistor as second transistor T₂ the connection of the second diode D₂ is the cathode thereof. In the case of a PNP bipolar transistor as second transistor T₂ it is the anode (FIG. 3). If the second transistor T₂ is a MOS transistor the second node of the second channel CH₂ may also be connected to a second auxiliary diode HD₂, which is connected to the third node K₂₃ of the second channel CH₂ and the orientation of which likewise conforms with the transistor type of the second transistor T₂.
K₂₃ third node of the second channel CH₂. The third node of the second channel CH₂ connects the second transistor T₂ to a first connection of the second LED chain L₂. It likewise optionally connects this to the second connection of a second auxiliary diode HD₂. This is helpful in particular if the second transistor T₂ is a MOS transistor. The orientation of the second auxiliary diode HD₂ then again conforms with the transistor type (P-channel MOS transistor or N-channel MOS transistor) of the second transistor T₂.
K₃₁ first node of the third channel CH₃. The first node of the third channel CH₃ connects the third power source, here the third current source IS₃, to the third transistor T₃ and the third resistor R₃, and a third voltage measurement means MU₃ for detecting the voltage drop across the third power source, here the third current source IS₃.
K₃₂ second node of the third channel CH₃. The second node of the third channel CH₃ connects the control connection of the third transistor T₃ to the third resistor R₃ and the third diode D₃. In the case of an NPN bipolar transistor as third transistor T₃ the connection of the third diode D₃ is the cathode thereof (FIG. 2). In the case of a PNP bipolar transistor as third transistor T₃ it is the anode (FIG. 3). If the third transistor T₃ is a MOS transistor the second node of the third channel CH₃ may also be connected to a third auxiliary diode HD₃, which is connected to the third node K₃₃ of the third channel CH₃ and the orientation of which likewise conforms with the transistor type.
K₃₃ third node of the third channel CH₃. The third node of the third channel CH₃ connects the third transistor T₃ to a first connection of the third LED chain L₃. It likewise optionally connects this to the second connection of a third auxiliary diode HD₃. This is helpful in particular if the third transistor T₃ is a MOS transistor. The orientation of the third auxiliary diode HD₃ then again conforms with the transistor type (P-channel MOS transistor or N-channel MOS transistor) of the third transistor T₃.
KBA coupling component assembly
L₁ first LED chain
L₂ second LED chain
L₃ third LED chain
L₁₁ first LED in the first LED chain
L₁₂ second LED in the first LED chain
L₁ₙ n^{th} LED in the first LED chain
L₂₁ first LED in the second LED chain
L₃₂ second LED in the second LED chain
L₄ₙ n^{th} LED in the second LED chain
L₃₁ first LED in the third LED chain
L₃₂ second LED in the third LED chain
L₃ₙ n^{th} LED in the third LED chain
MI₁ first current measurement means. This measurement means is used to detect an interruption in the first LED chain L₁.
MI₂ second current measurement means. This measurement means is used to detect an interruption in the second LED chain L₂.
MI₃ third current measurement means. This measurement means is used to detect an interruption in the third LED chain L₃.
MU₁ first voltage measurement means. This measurement means is used to detect an interruption in the first LED chain L.
MU₂ second voltage measurement means. This measurement means is used to detect an interruption in the second LED chain (L₂₁, L₂₂, . . . . L₂ₙ).
MU₃ third voltage measurement means. This measurement means is used to detect an interruption in the third LED chain (L₃₁, L₃₂, . . . . L₃ₙ).
R₁ first resistor
R₂ second resistor
R₃ third resistor
Rᵥ₁ first series resistor. The first series resistor can be connected in series for example to the first diode D₁ so as to make the switching thresholds between different channels asymmetrical. It is then necessary that the first series resistor deviates from another series resistor, for example from the second series resistor Rᵥ₂ in FIG. 6.
Rᵥ₂ second series resistor. The second series resistor can be connected in series for example to the second diode D₂ so as to be able to make the switching thresholds between different channels asymmetrical. It is then necessary that the second series resistor deviates from another series resistor, for example from the first series resistor Rᵥ₁ in FIG. 6.
Rᵥ₃ third series resistor. The third series resistor can be connected in series for example to the third diode D₃ so as to be able to make the switching thresholds between different channels asymmetrical. It is then necessary that the first series resistor deviates from another series resistor, for example from the second series resistor Rᵥ₂ and/or from the first series resistor Rᵥ₁.
SC hypothetical, exemplary short circuit
StOC short-to-open converter. This is a sub-device which, in the event of a short circuit of one LED or multiple LEDs within a considered LED chain, brings about a detection and/or subsequent signalling of an interruption of the current path within another LED chain of the at least two LED chains L₁, L₂, L₃.
SVE (multi-channel) current supply unit
T₁ first transistor
T₂ second transistor
T₃ third transistor
UWE monitoring unit
V_{bat} operating voltage connection

1.-10. (canceled)

11. A lighting device, particularly for vehicles, comprising
at least two LED chains, each LED chain including a respective series circuit including a plurality of LEDs,
a multi-channel power supply unit for the at least two LED chains including at least two power sources, wherein each LED chain is associated with a respective power source and each LED chain is electrically connected on the one hand to a power supply output connection of the respective power source included in the multi-channel power supply unit and on the other hand to a reference potential, and
a monitoring device for detecting a short circuit in a predefinable number of LEDs of any one of the at least two LED chains, wherein the monitoring device is provided with:
a detector for each LED chain for identifying and signalling an interruption in the current flow in the respective LED chain,
a controllable interrupter switch for each LED chain, the respective controllable interrupter switch for each LED chain including a respective control connection controllable by a respective control signal and a respective current path which can be switched to a conductive state or a non-conductive state depending on a magnitude of the respective control signal, wherein the one controllable interrupter switch for each LED chain is connected in series with the respective LED chain, and
at least one coupling component assembly connected respectively between each of the control connections of the at least two controllable interrupter switches for enabling a flow of current from the respective control connection of one controllable interrupter switch to the respective control connection of another controllable interrupter switch when a voltage of a value greater than or equal to a predefinable switching voltage is applied across the respective at least one coupling component assembly,
wherein, in the event of a short circuit of the predefined number of LEDs in the LED chain associated with the one controllable interrupter switch, the voltage of the value greater than or equal to the predefinable switching voltage is applied across the respective coupling component assembly, and therefore the control signal of the other controllable interrupter switch associated with another LED chain assumes a value that opens the other controllable interrupter switch, such that a detector associated with the other LED chain signals an interruption of the current flow in the other LED chain.

12. The lighting device according to claim 11, characterised in that the each coupling component assembly enables a flow of current in one direction or in another opposite direction only with a predefinable polarity of the voltage applied across the respective coupling component assembly or depending on the polarity of the voltage applied across the respective coupling component assembly.

13. The lighting device according to claim 11, characterised in that each of the coupling component assemblies has two or more diodes connected in an anti-parallel arrangement to enable a flow of current in both directions.

14. The lighting device according to claim 11, characterised in that the monitoring device, in a case that the at least two LED chains includes more than two LED chains, has a number of coupling component assemblies equalling a number of LED chains, wherein the control connections of the respective controllable interrupter switches associated with each of the LED chains are coupled cyclically by the respective coupling component assemblies and therefore as a ring circuit.

15. The lighting device according to claim 14, characterised in that each of the coupling component assemblies enables a respective flow of current in a same direction through the ring circuit.

16. The lighting device according to claim 11, characterised in that the monitoring device, in a case that the at least two LED chains includes more than two LED chains, has a number of coupling component assemblies equalling a number of LED chains, wherein the control connections of the respective controllable interrupter switches associated with each of the LED chains are coupled in a star circuit by the respective coupling component assemblies.

17. The lighting device according to claim 16, characterised in that each coupling component assembly enables unidirectional flows of current.

18. The lighting device according to claim 11, characterised in that the controllable interrupter switches are formed as bipolar, FET or MOS transistors.

19. The lighting device according to claim 11, characterised in that for each LED chain the respective controllable interrupter switch is connected such that the respective current is between the power supply output connection of the power supply unit and the respective LED chain.

20. The lighting device according to claim 11, characterised in that a number of LEDs for which the short circuit can be detected by the monitoring unit in the anyone of the least two LED chains is equal to greater than one.
